(19) United States
(12) Patent Application Publication
(10) Pub. No.: US 2010/0151845 A1
(43) Pub. Date: Jun. 17, 2010

(54) PRESENCE BASED COMMUNICATION CONTROL

(76) Inventor: Collin LeGault Rountree, Duluth, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 12/334,797

(22) Filed: Dec. 15, 2008

(51) Int. Cl. H04M 3/42; H04W 4/12

(52) U.S. Cl. 455/417; 455/466

(57) ABSTRACT

And integration of mobile communication devices and stationary communication devices is achieved by employing a computing device that is associated with a stationary communication device and that is coupled to a communications platform that can control call routing, call transfers and other message routing. When the computing device detects that a mobile communication device is proximate (i.e., such as by using paired blue tooth devices), the computing platform sends a command to the communications platform to have future calls sent to the stationary communication device and, if a call is active, to have that call transferred to the same. Similarly, if the mobile communication device is no longer proximate to the computing device, a command is sent to the communication platform to direct communications to the mobile communications device.

### BACKGROUND

The advent of the single number technology, connectivity took a giant step forward. Single number service, in general, allows a user to be assigned one telephone number which can be used to reach the user at a variety of locations. For instance, Movius Corporation has developed an MVP system that enables the single number service. In operation, a call to a subscriber's single number is routed to the MVP system. The MVP then attempts to contact the subscriber and anyone of a variety of potential destinations that the subscriber may be. For instance, the MVP can initiate calls to the subscriber's mobile telephone, office telephone, home telephone, secretary, etc. The single number service helps to simplify connectivity by allowing the subscriber to give out a single number that can be dialed by a party wanting to reach the subscriber, rather than the party having to dial a series of telephone numbers in search of the subscriber.

Although the single number service provides great benefits to both subscribers and parties attempting to reach a subscriber, there are still many needs in the industry for improving the connectivity capabilities. One such need falls into the category of converging technologies. What was once a novelty, today, owning and carrying a cellular telephone around with you has become a commodity, or is even perceived as a necessity. In addition to this, users typically also own a computer at home, a computer at the office, a home telephone and an office desk telephone. Between all of these devices, users are inundated with calls, text messages, emails, e-faxes, SMS's, FACEBOOK pokes, TWITTERS, etc. Unless one is extremely organized, it can be easy to get lost in the noise of it all. What is needed in the art is a technique to help users organize the influx of communications in a manner that is efficient and cost effective.

For instance, anyone that has combed through the thick and heavy bills received from their cellular service provider has most likely had a moment when they simply blew their monthly allocation of minutes right out of the water. Similarly, the discovery of the wonders of text messaging may quickly be followed by disillusionment when the bill is received. After situations such as these, a quick call to the service provider to get an upgraded plan usually ensues. Even with the kindness provided by roll-over minutes or unlimited weekend minutes, the unexpected can happen and before you know it, your monthly bill has doubled. However, an interesting survey would be to identify the number of cellular minutes, web surfing megabytes, and text message characters are actually expended while a user has immediate and/or convenient access to a land line telephone or an Internet connected computer. It would be greatly beneficial to have a technology that could detect such wastage and take actions to alleviate the same.

Another technological area that is drawing much attention is that of safety regarding the use of cellular or mobile telephones, especially while operating a vehicle. With the convergence of mobile telephones, PDAs, email and message reception and even Internet surfing all into a single compact mobile device, one can easily find themselves swerving off the road as they attempt to bang out a simple text message reply, read an email, or review the activity of one's FACEBOOK account. There is thus a need in the art for a technique to improve the operation of mobile devices to increase the safety of drivers. Further, drivers want to receive their messages regardless of the media and format in which they were created or transmitted. Thus, there is a need in the art to deliver messages in a manner that improves accessibility and does not have an adverse effect on safety.

Thus, it can be appreciated that there are several needs in the art with relationship to the convergence of the various messaging technology. These as well as other needs in the art are met by the various embodiments of the present invention that are presented herein, as well as variants thereof.

### BRIEF SUMMARY

Various embodiments of the present invention address the afore mentioned needs in the art, as well as other needs by providing a technique to manage, control, direct, or otherwise process communications and messages in a variety of manners based on the users proximity to various receiving devices. In general, a presence detection system is used to determine the proximity of a user, and then modify communication operations accordingly. As such, in one embodiment, a user has one portion of presence detection component in his or her proximity (i.e., a transmitter) and communication terminals that may be located in a variety of locations include other portions of the presence detection component. As the user moves into proximity to a communication terminal, the user and the communication terminal portions of the presence detection device detect each other, and update the knowledge of the user's presence. Further communications directed towards and from the user may then be processed in accordance with the current presence of the user.

More specifically, in one embodiment of the present invention, communications directed towards a user are controlled or processed based at least in part on the presence of the user. This embodiment operates by detecting, at a computing system, when a user-device comes into the proximity of the computing device (such as an office system). In response to detecting the user-device, the computing system sends a message to a communications platform instructing the communications platform to operate in a first mode of operation. Further, the embodiment operates by also detecting, at the computing system, when the user-device is no longer in the proximity.

In response to this information, the computing device sends a message to the communications platform instructing the communications platform to operate in a second mode of operation.

Further, embodiments of the invention may operate by also detecting, at a second computing system (such as a home system, a second office, etc.), when the user-device comes into its proximity. When this is detected, the second computing device sends a message to the communications platform instructing the communications platform to operate in a third mode. Further, if the second computing devices detects that the user-device is no longer in its proximity, it may respond by sending a message to the communications platform instructing the communications platform to return to the second mode. The communications platform, then in response to receiving a message directed towards an address associated with the user-device, directs the message to a termination point associated with the second computing system when the communications platform is operating in the third mode.

The communications platform, in response to receiving a message directed towards an address associated with the user-device, operates on the message based on the current mode of operation established for that user. For instance, the communications platform will direct the message to a termination point associated with an office (for example) computing system when the communications platform is operating in a first mode and direct the message to an alternate termination point when operating in the second mode.

In one embodiment, the user-device includes a transmitter, which could be based on any of a variety of technologies. The computing device detects the proximity of the user-device in this embodiment by detecting a signal transmitted from the user-device.

The user-device may be an independent item or device, may be integrated into another device such as a mobile communications device, or the transmitter for the user-device and the transmitter for a mobile communications device may be one and the same.

In one specific embodiment, the transmitter in the user-device is based on Bluetooth technology. In this embodiment the computing system controls a Bluetooth technology device and detecting when a user-device comes into the proximity with the computing device includes initially pairing the Bluetooth technology in the user-device with the Bluetooth technology controlled by the computing device. In addition, the computing device operates by sending an open connection command to the user-device and then receiving a valid response from the user-device.

In an embodiment in which the user-device is a mobile communications device, directing the message to an alternate termination point when operating in the second mode further comprises directing the message to the mobile communications device.

For example, if the message is an email message, an exemplary embodiment may operate by directing the email message to a termination point associated with the first computing device by sending the email to an email application running on the first computing device. If the alternate terminating point is a mobile communications device and, the exemplary system may direct the email message to the mobile communications device either as is, or by converting the email message to audio and then delivering an audio message to the mobile communications device.

Similarly, if the message is an SMS message, an exemplary embodiment may operate by directing the SMS message to a termination point associated with the first computing device by sending the SMS to an SMS application running on the first computing device. If the alternate terminating point is a mobile communications device and, the exemplary system may direct the SMS message to the mobile communications device either as is, or by converting the SMS message to audio and then delivering an audio message to the mobile communications device. Those skilled in the art will appreciate that any of a variety of messages and message types could be handled accordingly. For instance, voice message may be sent to a mobile communications device as is, but may be converted to text to send to a stationary platform.

In exemplary embodiments, the address associated with the user-device may be a telephone number and the user-device is the alternate terminating point and is a mobile communications device. In such an embodiment, if the message is a telephone call setup request, the communication platform directs the call setup request to the alternate termination device by initiating a call to the mobile communications device.

In addition, if the address associated with the user-device is an office telephone and the message is a telephone call setup request, then the communications platform operates to direct the call setup request to the termination point associated with the first computing system by initiating a call to the office telephone.

The various embodiments of the present invention may also operate to handle the situation in which a call may be currently active when a presence mode changes. For instance, suppose that the alternate communications device is a mobile communications device and, if the mobile communications device is engaged in a call when the communications platform switches to operating in the first mode. In this situation, the communications platform initiates a call transfer to the termination point associated with the first computing system. More specifically, the embodiment may operate by first displaying a prompt on a display device of the first computing system to request confirmation for transferring the call to the termination point associated with the first computing system. Then the communications platform may also initiate a call transfer to the termination point associated with the first computing system.

As another example, suppose that the alternate communications device is a mobile communications device and, the termination point associated with the first computing system is engaged in a call while the communications platform is operating in the first mode. In this embodiment, the system may operate to display a prompt on a display device of the first computing system to request confirmation for transferring the call to the mobile communication device. The communications platform may then initiate a call transfer to the mobile communication device in response to such confirmation.

It will also be appreciated that in various embodiments, the prompt may be rendered to the mobile communications device in addition to, or in lieu of rendering the prompt to the computing platform.

Thus, it will be appreciated that embodiments of the present invention may include a full system to implement all or a subset of the described features. Further, embodiments may simply include detection technology and an application or system as the computing platform. As such, embodiments may include modifications to the mobile devices, the communications platform and/or the computing platform, but some embodiments may only modify a subset of these systems. Even further, some embodiments may only interface to such systems and not modify any currently existing devices.

These and other embodiments of the invention will be more appreciated in referring to the following description.

### BRIEF DESCRIPTION OF THE SEVERAL VIEWS OF THE DRAWING

FIG. 1 is a system diagram illustrating an environment in which various embodiments of the present invention may be deployed.

FIG. 2A illustrates the operational state of the mobile device 110 being away from the computing device 122.

FIG. 2B illustrates the operation state of the mobile device 110 being proximate to the computing device 122.

FIG. 3 is a timing diagram illustrating exemplary operations for updating a presence state as a mobile device is moved from location to location causing presence state changes.

FIG. 4 is a simple state diagram illustrating the presence state change of a user. As described thus far, the presence state reflects the user's location.

FIG. 5 is a flow diagram illustrating the operation of an exemplary user interface that allows the user to monitor, interact with and control the operation of the system.

### DETAILED DESCRIPTION OF EMBODIMENTS OF THE INVENTION

The present invention, as well as features and aspects thereof, is directed towards providing an integration and/or convergence of mobile devices and stationary devices. This convergence uses a party's proximity to a device, along with the application of rules or heuristics, to govern the destination or current delivery mechanism of communications directed towards the party. In an exemplary embodiment, two communication devices are communicatively coupled to a common communications network, such as a telephony network, data network, or the like. One operational mode includes the two communication devices being distant from each other. In this mode, communications may be directed towards one of the communication devices. If the communication devices are brought in close proximity, then communications may be directed towards the second of the communication devices. Alternatively, other actions, as well as directing communications, may be taken as the communication devices change from the first and second modes of operation. Various advantages, aspects and features of the present invention will be more fully described and appreciated with reference to the various figures and the following descriptions of exemplary embodiments.

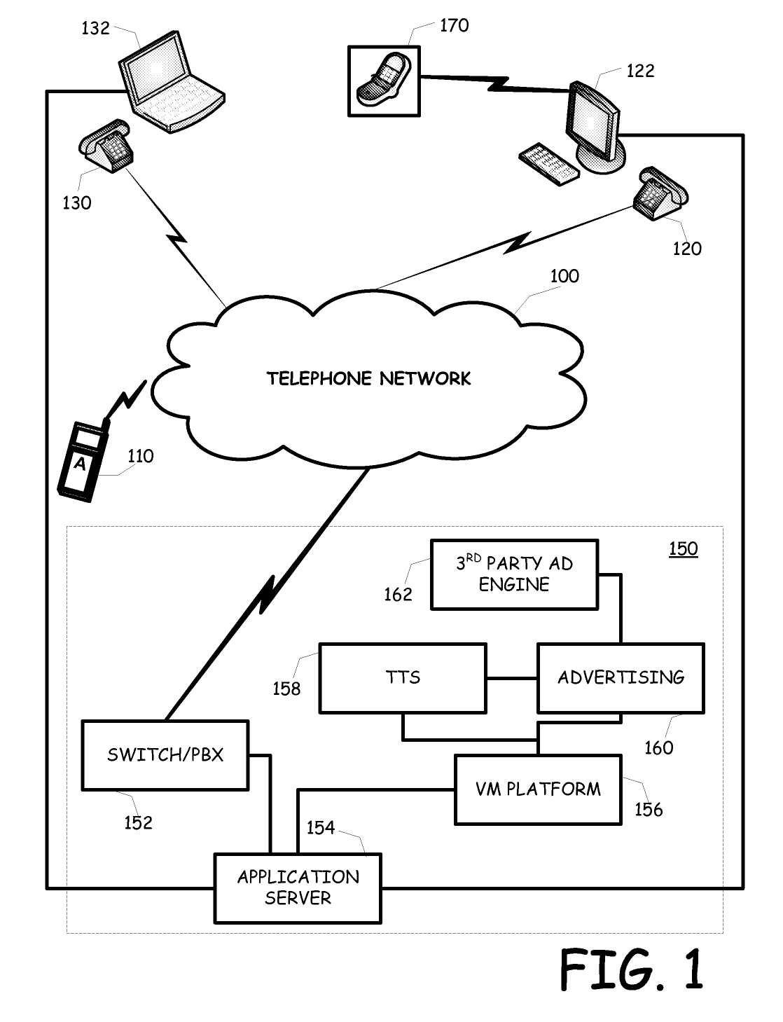

FIG. 1 is a system diagram illustrating an environment in which various embodiments of the present invention may be deployed. The communications network 100 is shown as being a telephone network but, it should be appreciated that many other types of networks may be included in various embodiments, including but not limited to mobile telephone networks, paging networks, data networks, wireless networks, or even application based networks, such as social networking networks. Communicatively coupled to the network 100 are three communication devices: a mobile device 110 and an office-based stationary device 120 and a home-based stationary device 130. It should be appreciated that the communication devices do not have to include mobile and stationary devices. It is feasible that in some applications only mobile communication devices may be deployed and in other applications, only stationary devices may be deployed. The identified location of the stationary devices is provided only for purposes of illustration.

Also communicatively coupled to the network 100, is a communications platform 150. Depending on the underlying network in the various embodiments, the communications platform 150 may take on a variety of forms and functions. In the environment illustrated in FIG. 1, the communications platform 150 interfaces to the telephone network 100 through a telecommunications switch or PBX switch or other SWITCH 152. An application server 154 interfaces to the telecommunications switch 152 and a voice mail platform 156. The application server 154 also has a communication path to computing devices 122 and 132 that are respectively associated with communication devices 120 and 130. Typically, this communication path would be a data path, such as via a local network or the Internet but, it should be appreciated that the application server 154 may interface with the computing devices 122 and 132 through any of a variety of communication means and channels.

The voice mail platform 156 either includes or interfaces with a text-to-speech server (TTS) 158 and an advertising server 160. Further, the advertising server may receive and prepare advertisements in response to requests and/or data received from a third party advertisement engine 162.

By referring to the exemplary environment illustrated in FIG. 1, a variety of features, operations and aspects of the present invention are presented. It should be noted that although a variety of operations are presented, the present invention does not necessarily require each described operation but rather, various embodiments may use only a subset or all of the described operations, features or aspects, as well as others not described.

It should be appreciated that various embodiments utilize a single mailbox type system, although some embodiments may not necessarily require such a system. A single mailbox is similar to a single number in that all calls directed to and terminated to a users number, regardless of the device used, will be terminated to a single voice mailbox. In the illustrated embodiment, a single number (404) 555-9595 is assigned to a particular party that utilizes mobile communications device 110, as well as the communications device 120 (and associated devices 122 and 170) and communication device 130 (and associated device 132).

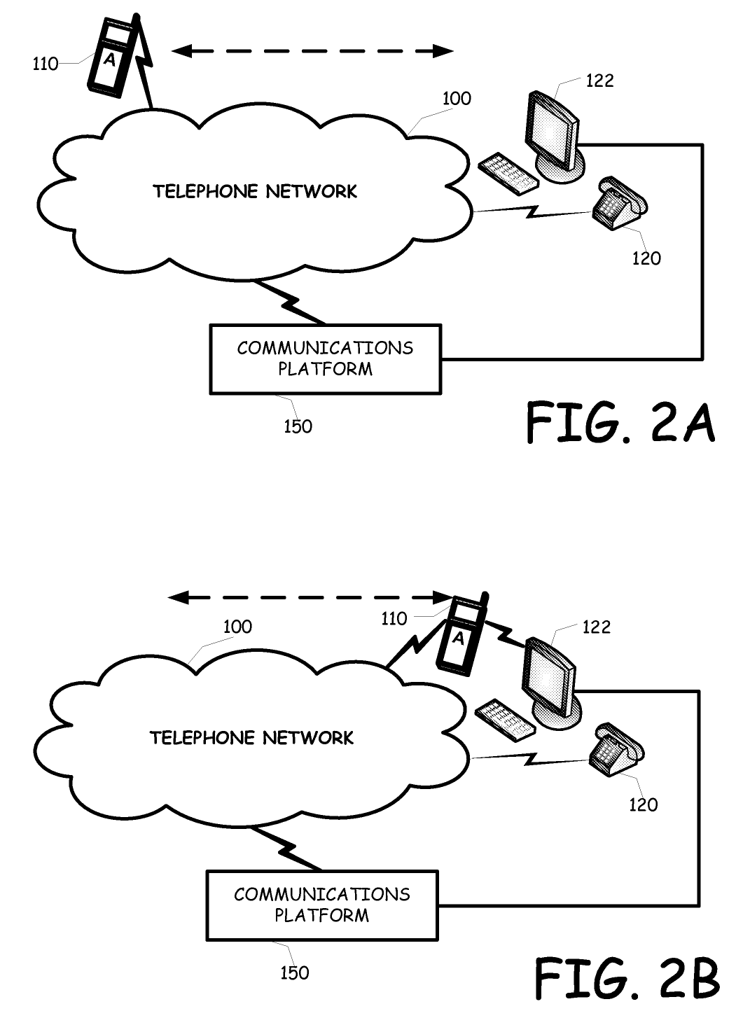

FIGS. 2A and 2B are simplified system diagrams illustrating select components from FIG. 1 to facilitate describing a state-change operation of one exemplary operation. The application server 154 within the communications platform 150 processes a state variable for the user associated with a particular assigned single number. The state variable operates to indicate one of at least two possible states (a) the user is co-located with (or proximate to) the communication device 120 and computing platform 122 or (b) the user is not proximate to the communication device 120 and computing platform 122. In the various embodiments, a presence detection system is used to trigger the transition between the various states. The presence detection system may function automatically and autonomously or, it may be subject to control by a user. Certainly, it will be appreciated that other states may also be incorporated into the various embodiments of the invention and although an exhaustive list is not provided, non-limiting examples of other states may include the following:

(1) user is proximate to stationary station X (where X can identify one of a variety of possible stations such as office, home, etc.)

(2) user is not proximate to stationary station

(3) user is proximate to stationary station X but has disabled state change

(4) user is proximate to stationary station X but has full battery charge

(5) user is proximate to stationary station X but signal is weak or intermittent

(6) user is proximate to stationary station X, but stationary station X is utilized already

FIG. 2A illustrates the operational state of the mobile device 110 being away from the computing device 122. In this state, an exemplary embodiment operates by directing calls to the user's number to the mobile device 110. In other embodiments, other operations may also be performed in this state. For instance, calls to the user's number may result in broadcast call attempts to all locations on a user's reach list or sequencing through the caller's reach list. In any of these cases, in this state the user may ultimately be able to receive the call at the mobile device 110. As the user moves proximate to the computing device or station 122, a presence detection system in the computing device 122 detects the presence of the mobile device 110.

FIG. 2B illustrates the operational state of the mobile device 110 being proximate to the computing device 122. Although in the illustrated embodiment the detection system appears to operate between the computing device 122 and the mobile communications device 110, it should be appreciated that the detection system may be separated out from one or both devices. For instance, the user may carry a fob, pendant or other apparatus that contains a device that can communication with the detection system. In addition, the detection system may exist as a separate unit outside of the computing device 122 and then interface with the computing device 122. In the illustrated embodiment, as the mobile communications device 110 becomes proximate with the computing device 122, a presence detection system in the computing device 122 detects the presence of the mobile communications device 110. As a result, the presence state is then updated and current action or actions on future activity can be controlled based on the new status.

The presence detection application continues to monitor the mobile device 110 to verify that it is still proximate. If at anytime it is determined that the mobile device is no longer present, then the presence state can again transition. It should be appreciated that hysteresis may be built into the presence detection algorithm to ensure that a mobile device that is residing on the edge of the transmission range for the presence detection system does not result in a continuous toggling between the states.

The technology employed in the presence detection system can be based on a variety of technologies. Non-limiting examples of the presence detection system technology may include Bluetooth, IEEE 802.11, unlicensed RF spectrum transmissions, infrared, super sonic, audio, magnetic, RF transmission, or any other wireless transmission means, as well as any location detection based technologies such as triangulation and/or GPS.

In an exemplary embodiment, the presence detection system is based on Bluetooth technology. In such an embodiment, utilizing Bluetooth as a presence detection protocol, the typical instantiation is illustrated by a Bluetooth capable mobile communications device paired with one or more computing devices. The common Bluetooth pairing process ensures that the controlling device is limited to the user's Bluetooth device for updates to the presence state. Pairing is a simple process where a validation key is used by both the personal computer and the mobile communications device to allow for connections between the devices. Pairing may or may not be used but adds an additional level of security that only user specified devices will be allowed to control the state changes detected by the computing devices.

In the Bluetooth embodiment, detection occurs when the Bluetooth device on the computing device searches for and finds a selected paired Bluetooth device. Other paired or non-paired Bluetooth devices while present will not impact the presence state. When a paired and selected device is detected, then the state machine of the automatic presence solution will be updated. This validates that the paired device is in the proximity of the presence application and is turned on and active. The actions that will be taken after detection will depend on the user's preferences, configuration settings and any rules or heuristics employed by the application server. After the device is detected the Bluetooth device on the computing device will poll the paired device to ensure it is still available. If the paired device becomes unavailable, then the state machine is updated again.

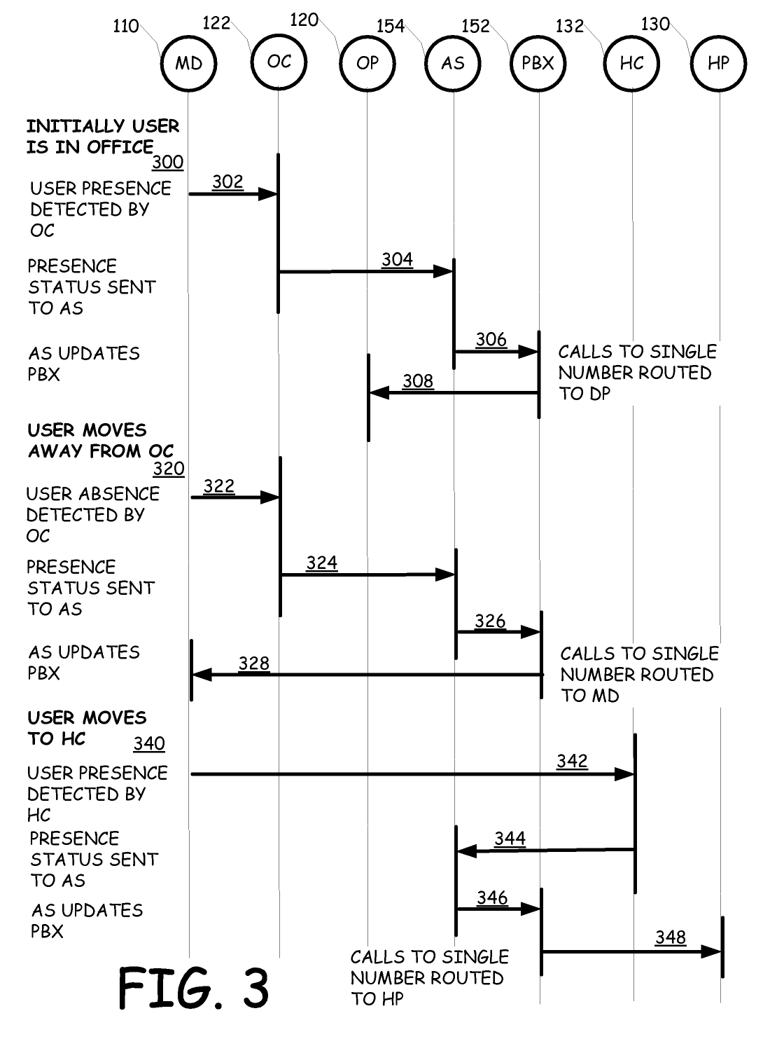

FIG. 3 is a timing diagram illustrating exemplary operations for updating a presence state as a mobile device is moved from location to location causing presence state changes. The components from FIG. 1 are presented in FIG. 3 along the top as destinations for various communications, status indications, control commands, etc.

The illustrated components include the mobile communication device MD 110, the office telephone OP 120, the home telephone HP 130, the office computing device OC 122, the home computing device HC 132, the SWITCH 152 and the application server 154.

Initially, the presence state indicates that the user is in the office 300 and comes into proximity with the office computing device 122. When the office computing device 122 detects the presences of the user 302, the office computing device 122 sends a notice 304 to the application server 154 regarding the presence status for the user. Once the application server 154 is aware of the presence state, the application server 122 sends a notice 306 to the SWITCH to indicate that calls to the user's single number should be directed to the user's office telephone 120. Subsequently, all calls to the user's single number are then routed 308 to the office telephone 120.

If the user then moves away from the office computing device 122, the office computing device 122 detects that the presence state for the user has changed 302. The office computing device 122 then sends a presence status notice 324 to the application server 154. Once the application server 154 is aware of the presence state, the application server 154 sends a notice 326 to the SWITCH to indicate that calls to the user's single number should be directed to the user's mobile communications device 110. Subsequently, all calls to the user's single number are then routed 328 to the mobile communication device 110.

If the user then travels home and comes into proximity 340 with the users home computing device 132, the home computing device 132 detects that the presence state for the user 342. The home computing device 132 then sends a presence status notice 344 to the application server 154. Once the application server 154 is aware of the presence state, the application server 154 sends a notice 346 to the SWITCH to indicate that calls to the user's single number should be directed to the user's home telephone 130. Subsequently, all calls to the user's single number are then routed 348 to the home telephone (or other termination device associated with the home computing device) 130.

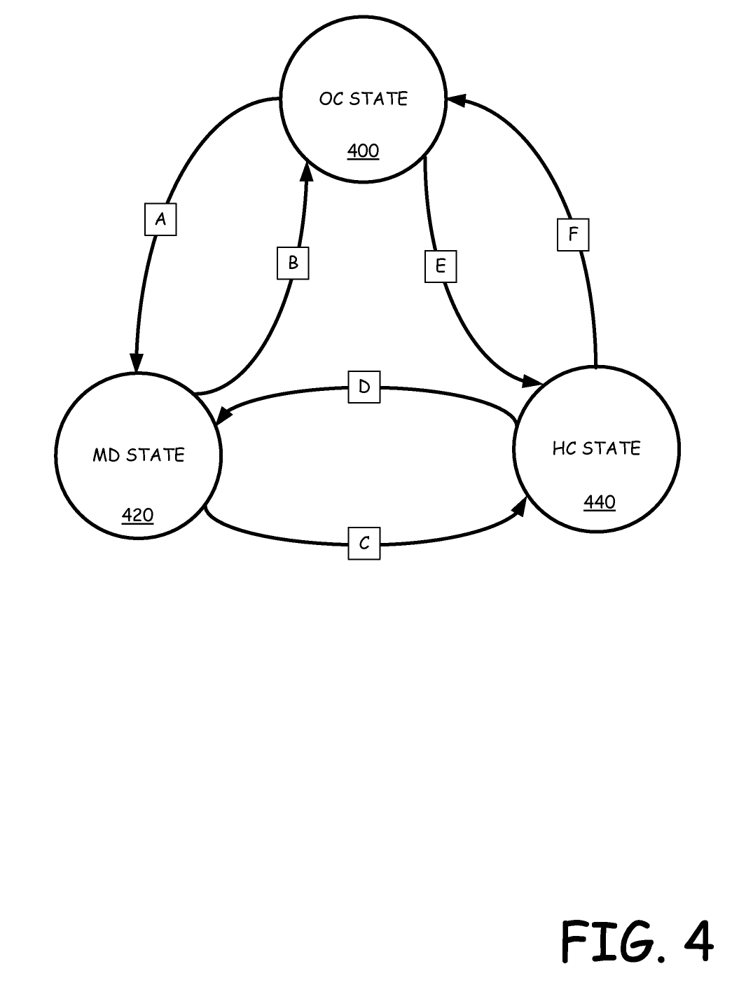

FIG. 4 is a simple state diagram illustrating the presence state change of a user. As described thus far, the presence state reflects the user's location. This is performed by a presence detector application running on a computing device, a separate presence detection system or the like. For instance, if a user is residing in state of being proximate to the office computing device (OC STATE) 400, if the user moves away from the office computing device, a transition A occurs thereby causing the presence state to transition to the mobile device state (MD STATE) 420. If the user again becomes proximate to the office computing device, a transition B occurs thereby causing the presence state to transition back to the OC STATE 400. However, if the user moves into proximity to the home computing device, a transition C occurs thereby causing the presence state to transition to the home computing state (HC STATE) 440. If the user moves away from the home computing device, a transition D occurs thereby causing the presence state to transition back to the MD STATE 420.

Each of the afore mentioned transitions are invoked as the result of the presence detection mechanism operating within or in conjunction with the office computing device or the home computing device, detecting the presence of the user. As such, a direct transition between the OC STATE 400 and the HC STATE 440 is not readily feasible without first transitioning through the MD STATE 420. However, in some embodiments, additional criteria can be applied to control the state transitions. For instance, if a user is in a meeting that is not proximate to either the office computing device or the home computing device, the user may still wish calls to be routed to a destination other than the mobile communications device. As such, various embodiments may provide an interface for the user to force a presence state change without regard to the user's proximity to a computing device. For instance, the user may enter a dial code or access the application server and select an option to force the system to operate as though the OC STATE 440 or the HC STATE 440 is active. As a result, the system will take actions in accordance with the forced state. As a non-limiting example, calls to the user's single number may be directed the user's office telephone device or home telephone device depending on the forced state.

Other actions may also result in forced state changes. For instance, if the battery power in the mobile device decreases beyond a threshold value, this may trigger a transition B or C to the OC STATE 400 or the HC STATE 440 respectively. In addition, if the presence state is in the OC STATE 400 and the office computing device detects that the office telephone device is off hook (i.e., presently in another call, broken, disabled, etc.), the office computing device may automatically cause a transition A to the MD STATE 420. This example similarly applies if the state is the HC STATE 440. It should be appreciated that many other triggers may also be used to invoke a transition between the states and the illustrated examples are provided only for descriptive purposes and should not be construed as the domain of possible triggers.

Throughout the description, the operation associated with different presence states has been described as causing calls to be routed to an applicable destination. For instance, in the OC STATE 400, calls are routed to an office telephone. However, it will be appreciated that the various embodiments of the present invention may also result in a wide variety of other actions. As non-limiting examples, some of these actions are presented in this description.

Call Transfer. One application that can be included in various embodiments is a call transfer feature. In general, a party may begin a call while residing in one presence state. The call may be one that is initiated by the party or received by the party. When the party then moves to a different presence state, the call can be transferred to an alternate communication device. More specifically, suppose a party receives an incoming call while he or she is residing in a mobile presence state (i.e., is not proximate to any stationary computing devices). The call will be directed to the party's mobile communications device (such as a cellular telephone, mobile VoIP telephone, or other mobile communications device). The party then answers that call and while engaged in the call, the party moves proximate to a computing device thereby resulting in a presence state change. For instance, referring to FIG. 3 this may result in a change from MD STATE 420 to either OC STATE 400 or HC STATE 440. At this point, the appropriate computing device detects the presence of the party and then begins actions to transfer to the call to a telephone device associated with the computing device. In an exemplary embodiment, this transfer may include requesting the communications platform to initiate a call to the associated telephone device. When the party picks up the incoming call on the associated telephone device, the party can then hang up the mobile device and continue the call on the associated telephone device without dropping and having re-initiate the call.

Email Delivery. A large number of email delivery applications can be deployed in various embodiments of the present invention. One such application includes modifying the manner or the format in which email is delivered based on the presence state. For instance, if a user is residing in the OC STATE 400, emails may be directed to the user's computing device rather than the users mobile device. If the user moves to cause a transition to the MD STATE 420, then emails may then be directed to the user's mobile device. In addition, emails that had been previously sent to the user's computing device but have not been read may also be resent to the user's mobile device. Similarly, if the user transitions from the MD STATE 420 to either the OC STATE 400 or HC STATE 440, emails that had previously been received on the mobile device can be transferred over to the appropriate computing device and/or deleted from the mobile device. A wide variety of functions can be implemented to provide synchronization and message management. For instance, messages read on one device can be tagged for transfer or synchronization. As such, if a user reads an important message on his or her mobile device but does have the ability to presently respond (i.e., does not have necessary information, resources, etc.), the user can tag the message. Depending on the various embodiments, the tag may result in causing a variety of actions and/or multiple tag-types may be used. As a non-limiting example, a message tagged on a mobile device may be transferred to the users office computer, marked as un-read and flagged, when the presence state transitions to the OC STATE 400. Advantageously, such applications help to provide automated management of a user's email.

Email, Text and SMS Rendering. It may be desirable for a user to have email, text messages and/or SMS messages rendered differently based on the current presence state of the user. For instance, if the user is in the OC STATE 400 or HC STATE 440, it may be desirable for email to be rendered in the standard textual format through the user's email application. However, if the user is in an MD STATE 420, the user may not be able to divert attention to read the email messages. As such, an application may operate to convert email messages from text to voice and delivery the audible email messages to the user's mobile device when the user is in the MD STATE 420. Such a feature may be implemented in a variety of manners. For instance, in one embodiment, the communications platform may convert the messages to audio and deliver an audio message as an attachment to an email or message, may delivery an audio message directly to the mobile device which can immediately play the message or prompt the user to allow the playback. Also, the communications platform can deliver the message in the form of a voice call. It should be appreciated that in the various embodiments, the features can be implemented by modifying the termination device, the communications

Device Bridging. Device bridging refers to modifying or changing the medium over which a communication device is communicating. Incorporating this feature into various embodiments enables a user to use a single communication device but, to change the medium used for communicating based on the presence state. More specifically, if a user is in the MD STATE 420 calls are directed towards the users mobile communications device over a mobile communication network. If the mobile communications device is a cellular telephone, then the communications medium will be the appropriate cellular communications network. If the user moves into proximity with a computing device, the presence of the user may be detected and then the communications medium may be changed. The new communications medium may consist of a totally different technology, such as plugging and RJ-11 connector into the mobile communications device and using POTS service to access the PSTN, or a similar technology such as a local micro-cell based on the same or similar cellular communications protocol. In some embodiments, the mobile communications device may communicate over a standard cellular network while in one mode, and then switch over to an Mobile Virtual Network Operator (MVNO) network in another presence mode. Other communication mediums are also anticipated such as infrared, RF transmission, etc. Advantageously, this feature enables a user to maintain use of the same communications device but, can reduce the amount of cellular minutes consumed by using the alternate communications medium when the user is proximate a computing device. Referring to FIG. 1, an example of this application is illustrated. The mobile device 170 is shown as being in communication through a wireless channel with the computing device 122. This wireless channel may be the communication medium alone or, be combined with the presence detection technology. In various embodiments the mobile device 170 can be used to interface with the telephone network 100 through the computing device 122 or through the application server 154. As such, the mobile device could be used as a VoIP telephone or use some other local communications medium.

User Interface for Computing Device. Various embodiments may include a user interface running on the computing devices 122 and 132. The user interface enables a user to configure, control and monitor the operation of the embodiment. The user can configure the system identifying the single number, selecting thresholds for changing presence states, defining a schedule to control the changes in presence states, identifying operating characteristics based on the presence state, etc. More specifically, if the user is in an environment in which he or she frequently moves into and out of proximity with the computing device, the user may want to augment the operation of the system. Such augmentation may include setting a large time threshold that must be met before transitioning from the MD STATE 420 to the OC STATE 400 or HC STATE 440. Such an augmentation would allow the user to come into proximity with the computing device and then leave without having to transition from the mobile communications device to the stationary device and then back to the mobile communications device.

Alternatively or in addition to, the user interface may allow the user to disable one or more applications or features. For instance, in the environment depicted above, a user may disable the call transfer function so that if the user is in a call, the call will not be transferred as he or she moves into and out of proximity of the computing device.

Embodiments may also allow a user to enter a schedule to control the changes in the presence state. For instance, if the user is in a meeting, the user may force the presence state to be OC STATE 400 and prevent a transition to MD STATE 420 during the meeting.

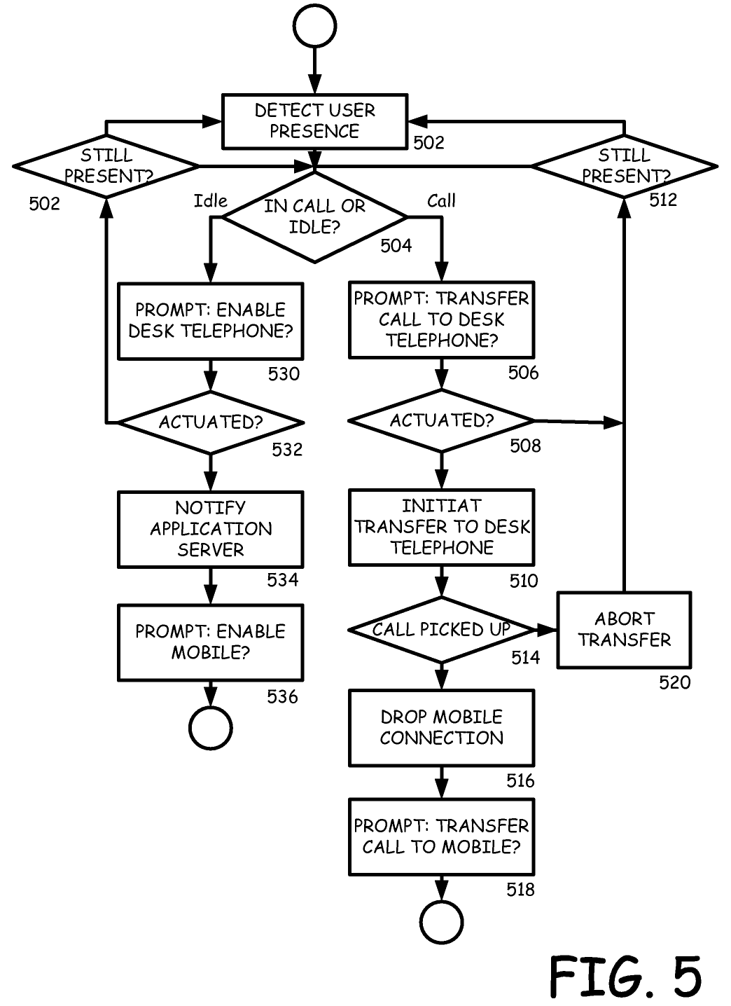

The user interface may also allow the user to monitor and control the operation of the system. This can best be illustrated by providing an example depicted in the flow chart of FIG. 5 taking reference to FIG. 3 and FIG. 4. If the user is presently away from a computing device, the MD STATE 420 is active. As the user becomes proximate to the home computing device 132, the user's presence is detected 342 502. The home computing device 132 detects the user's presence 502 and determines if the user is presently in a call or idle 504. If the user is in a call, then the computing device presents a prompt on the display to allow the user to transfer the call to the desk telephone 506. If the user actuates the correct control or otherwise responds to the prompt 508, the transfer of the current call is to the user's desk telephone is initiated 510. Those skilled in the art will understand the various telecommunications actions that can and must take place in order to perform the transfer. If the user does not actuate a control or respond to the prompt, after a delay processing may continue at decision block 512. At decision block 512, if the user is still present, processing continues at decision block 504 immediately or after a slight delay. Otherwise, processing returns to step 502 to detect if and when the user becomes present again.

Returning to step 510, after the call is transferred, the user's desk telephone may begin to ring. If the user picks up the desk telephone receiver 514, the mobile connection is dropped 516. In addition, the computing system may then present a prompt to the user indicating that the call can be transferred back to the mobile device 518. However, if the user does not pick up the call at the user's desk telephone within a given period of time, the transfer of the call is aborted 520 and processing continues at step 512.

Returning to decision block 504, if the user is not presently in a call, the computing device may prompt the user to actuate a control or respond to the prompt requesting the desk telephone to be enabled 530. If the user actuates the control or responds to the prompt 532, the computing device notifies the application server to direct future calls to the user's desk telephone 534. At this point, the computing device may then again prompt the use to enable the mobile telephone 536. Thus, prior to leaving the proximity of the computing device, or if the user anticipates departing soon, the user can force calls to be directed to the mobile device.

Returning to decision block 532, if the user does not actuate the control or respond to the prompt to enable the desk telephone within a given period of time, processing continues at decision block 538 where the presence state of the user is again examined. If the user is still present, processing continues at decision block 504. Otherwise, processing continues at step 502.

It should be appreciated that although the presented embodiment is shown as providing prompts at steps 506, 518, 530, and 536, any or all of the prompts can omitted and the actions may take place automatically.

As previously mentioned, the presence detection can be performed using a variety of technologies and configurations. Although exemplary embodiments of the invention have primarily been described in conjunction with Bluetooth technology and pairing of the mobile device with the computing devices using Bluetooth technology, it should be appreciated that a variety of other technologies may also be employed. In fact, any technology that enables the computing device to determine that the user is in the proximity of the computing device is anticipated. For instance, locating tracking systems as well as passive receivers, RFIDs, or other transmitting or beaconing technologies may also be used. In addition, the various embodiments do not require the presence detection technology to actually be integrated into the mobile devices and/or the computing devices. For instance, the presence detection device interfacing to the computing device may include a stand alone system with some wired or wireless communication link to the computing device, a dongle, a PC card, a USB plug in, or the like.

Likewise, the presence detection technology associated with the user may include a key fob, a pocket trinket, an ear phone or headset, or any other device. Further, some embodiments may even simply utilize manual actions to provide the presence detection. For instance, when the user accesses his or her computing device, the presence detection system may automatically conclude the user is present. In addition, the user may have a certain key, soft key or application that needs to be actuated to indicate the user is present. In one embodiment, a PC based camera may be used to detect and recognize the presence of the user. Further, if the user fails to actuate or interact with the computing device for a given period of time, the presence detection system may conclude that the user is no longer present. Alternatively, the presence detection system may periodically prompt the user to take an action to verify that he or she is still present. For instance, a pop-up prompt that requires the user to close may be used. Those skilled in the art will appreciate that a variety of other mechanical, procedural and functional mechanisms can be employed to trigger the transfer from away states to presence states.

In the described embodiments, the presence detection technology, such as Bluetooth or other transmitting technologies has only been described as being used for detection. However, it should be appreciated that in other embodiments, the Bluetooth or transmitting technology may also be used for advanced presence applications. For instance, information from a paired device may be transmitted to the computing platform over the Bluetooth or transmitting channel to further control the actions to be taken after detection. For instance, email inboxes may be synchronized or communication mediums may be changed as non-limiting examples.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

In this application the words “unit” and “module” are used interchangeably as are “party”, “user”, and “subscriber”. Anything designated as a unit or module may be a stand-alone unit or a specialized module. A unit or a module may be modular or have modular aspects allowing it to be easily removed and replaced with another similar unit or module. Each unit or module may be any one of, or any combination of, software, hardware, and/or firmware.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. A method for controlling communications directed towards a user, the method comprising the steps of:
detecting, at a first computing system, when a user-device comes into the proximity;
sending, from the first computing system, a message to a communications platform instructing the communications platform to operate in a first mode;
detecting, at the first computing system, when the user-device is no longer in the proximity;
sending, from the first computing system, a message to the communications platform instructing the communications platform to operate in a second mode;
the communications platform, in response to receiving a message directed towards an address associated with the user-device, being operable to:
direct the message to a termination point associated with the first computing system when the communications platform is operating in the first mode; and
direct the message to an alternate termination point when operating in the second mode.

2. The method of claim 1, wherein the alternate termination point is a mobile communications device and the user-device includes a transmitter and, the step of detecting, at a first computing system, when a user-device comes into the proximity further comprises detecting a signal transmitted from the mobile communications device.

3. The method of claim 2, wherein the transmitter in the user-device is based on Bluetooth technology and the first computing system controls a Bluetooth technology device, and the step of detecting, at a first computing system, when a user-device comes into the proximity further comprises the steps of:
initially pairing the Bluetooth technology in the user-device with the Bluetooth technology controlled by the first computing device;
sending an open connection command from the first computing system; and
receiving a valid response from the user-device.

4. The method of claim 3, wherein the user-device is a mobile communications device and, the step of directing the message to an alternate termination point when operating in the second mode further comprises directing the message to the mobile communications device.

5. The method of claim 1, further comprising the steps of:
detecting, at a second computing system, when the user-device comes into the proximity;
sending, from the second computing system, a message to the communications platform instructing the communications platform to operate in a third mode;
detecting, at the second computing system, when the user-device is no longer in the proximity;
sending, from the second computing system, a message to the communications platform instructing the communications platform to return to the second mode;
the communications platform, in response to receiving a message directed towards an address associated with the user-device, being operable to:
direct the message to a termination point associated with the second computing system when the communications platform is operating in the third mode.

6. The method of claim 5, wherein the message is an email message and the step of directing the email message to a termination point associated with the first computing device comprises sending the email to an email application running on the first computing device.

7. The method of claim 6, wherein the alternate terminating point is a mobile communications device and, the step of directing the email message to the mobile communications device comprises converting the email message to audio and then delivering an audio message to the mobile communications device.

8. The method of claim 5, wherein the message is an SMS message and the step of directing the SMS message to a termination point associated with the first computing system comprises sending the SMS to an SMS application running on the first computing device.

9. The method of claim 8, wherein the alternate terminating point is a mobile communications device and, the step of directing the SMS message to the mobile communications device comprises converting the SMS message to audio and then delivering an audio message to the mobile communications device.

10. The method of claim 5, wherein the address associated with the user-device is a telephone number, the user-device is the alternate terminating point and is a mobile communications device, and wherein the message is a telephone call setup request and, the step of directing the call setup request to the alternate termination device further comprises initiating a call to the mobile communications device.

11. The method of claim 5, wherein the address associated with the user-device is an office telephone and wherein the message is a telephone call setup request and, the step of directing the call setup request to the termination point associated with the first computing system comprises initiating a call to the office telephone.

12. The method of claim 1, wherein the alternate communications device is a mobile communications device and, if the mobile communications device is engaged in a call when the communications platform switches to operating in the first mode, further comprising the step of the communications platform initiates a call transfer to the termination point associated with the first computing system.

13. The method of claim 1, wherein the alternate communications device is a mobile communications device and, if the mobile communications device is engaged in a call when the communications platform begins operating in the first mode, further comprising the steps of:
displaying a prompt on a display device of the first computing system to request confirmation for transferring the call to the termination point associated with the first computing system; and
the communications platform initiating a call transfer to the termination point associated with the first computing system.

14. The method of claim 1, wherein the alternate communications device is a mobile communications device and, if the termination point associated with the first computing system is engaged in a call while the communications platform is operating in the first mode, further comprising the steps of:
displaying a prompt on a display device of the first computing system to request confirmation for transferring the call to the mobile communication device; and
the communications platform initiating a call transfer to the mobile communication device in response to such confirmation.

15. The method of claim 1, wherein the alternate communications device is a mobile communications device and, if the mobile communications device is engaged in a call when the communications platform begins operating in the first mode, further comprising the steps of:
rendering a prompt on the mobile communications device to request confirmation for transferring the call to the termination point associated with the first computing system; and
the communications platform initiating a call transfer to the termination point associated with the first computing system upon receiving confirmation.

16. The method of claim 1, wherein the alternate communications device is a mobile communications device and, if the termination point associated with the first computing system is engaged in a call while the communications platform is operating in the first mode, further comprising the steps of:
rendering a prompt to the mobile communication device to request confirmation for transferring the call to the mobile communication device; and
the communications platform initiating a call transfer to the mobile communication device in response to such confirmation.

17. A method for controlling communications for a user, the method comprising the steps of:
pairing blue tooth communication devices in a first computing device and a mobile communications device;
the blue tooth communication device in the first computing device detecting the presence of the blue tooth communication device in the mobile communications device and in response, sending a message to a communications platform instructing the communications platform to direct future communications for the user to a first communications termination device and, if the user is actively engaged in a telephone call, sending a message to the communications platform to initiate the transfer of the active call to the first communications termination device; and
the blue tooth communication device in the first computing device detecting the absence of the blue tooth communication device in the mobile communications device and in response, sending a message to a communications platform instructing the communications platform to direct future communications for the user to a the mobile communications device.

18. The method of claim 17, further comprising the step of:
further, in response to the blue tooth communication device in the first computing device detecting the presence of the blue tooth communication device in the mobile communications device, displaying a prompt on a display of the first computing device requesting the user to take an action prior to the step of sending a message to the communications platform to initiate the transfer of the active call to the first communications termination device.

19. The method of claim 17, further comprising the step of:
further, in response to the blue tooth communication device in the first computing device detecting the presence of the blue tooth communication device in the mobile communications device, displaying a prompt on a display of the first computing device requesting the user to take an action prior to the step of sending a message to the communications platform to initiate the transfer of the active call to the first communications termination device and,
in the event of transferring the call, the call ending or if a call was not active, displaying a prompt on the display of the first computing device requesting the user to take an action prior to enabling the step of the blue tooth communication device in the first computing device detecting the absence of the blue tooth communication device in the mobile communications device.

20. A communication control system comprising:
a communications platform that is operative to direct communications intended for a single number to at least one of a plurality of communication devices;
a first computing device associated with a first terminating communication device, the first computing device including a presence detection device and being communicatively coupled to the communications platform, the first termination communication device being communicatively coupled to a communications network;
a presence indicator device;
the first computing device being operable to:
receive a first indication from the presence detection device that the presence indicator has been detected in close proximity;
in response to receiving the first indication, sending a request to the communications platform to request all communications directed to the single number to be directed to the first termination communication device;
receiving a second indication from the presence detection device that the presence indicator is not in close proximity;
in response to receiving the second indication, sending a request to the communications platform to request all communications directed to the single number to be directed to an alternate termination communication device.

21. The communication control system of claim 20, wherein the first computing device is further operable to:
if a call to the single number is currently active when the first computing device receives the first indication, then:
rendering a prompt to request confirmation to transfer the active call to the first termination communication device;
receiving the confirmation for the file transfer; and
sending a command to the communications platform to transfer the active call to the first termination communication device.

22. The communication control system of claim 21, wherein the first computing device is further operable to:
if a call to the single number is currently active on the first termination communication device:
rendering a prompt to request confirmation to transfer the active call to the alternate termination communication device;
receiving the confirmation for the file transfer; and
sending a command to the communications platform to transfer the active call to the alternate termination communication device.
